(19) United States
(12) Patent Application Publication
(10) Pub. No.: US 2008/0168268 A1
(43) Pub. Date: Jul. 10, 2008

(54) Method For Providing a Secured Communication Between a User and an Entity

(75) Inventor: Herve Chabanne, Paris (FR)

Correspondence Address: PATZIK, FRANK & SAMOTNY LTD., 150 SOUTH WACKER DRIVE, SUITE 1500, CHICAGO, IL, 60606, US

(73) Assignee: Sagem Securite, Paris (FR)

(21) Appl. No.: 11/994,249

(22) PCT Filed: Jun. 14, 2006
(86) PCT No.: PCT/FR2006/001345

§ 371 Date: Dec. 28, 2007

(30) Foreign Application Priority Data
Jun. 30, 2005 (FR) 0506704

(51) Int. Cl. H04L 9/00

(52) U.S. Cl. 713/150

(57) ABSTRACT

The invention relates to a method for providing a secured communication between a user and an entity containing a first set of biometric data relating to the user. According to the invention, a second set of biometric data relating to the user is obtained. An error correction protocol is applied to the first set of biometric data and to the second set of biometric data in such a way that the resulting data is identical to a pre-determined level of probability. A secret amplification phase is implemented, in which a hasting function is applied to the resulting data in order to obtain a key which is common to the user and the entity.

The present invention relates to the securing of a communication link between a user and an entity.

Communication security is a major issue when it comes to avoiding fraud that can take various forms. In particular, a communication link needs to be secured so as to prevent a passive attacker, listening in to this link, from obtaining the information transmitted thereon.

It will be noted that the term communication link should be considered in the broad sense. It may, in practice, be a link of any physical type, such as a simple communication bus or wired or wireless, permanent or occasional, telecommunication channel supporting any communication protocol.

The use of biometric data to secure a communication link has been proposed. The biometric data, which is physical information characteristic of respective individuals, such as fingerprints, iris prints, voice prints, in practice presents the advantage of being naturally and permanently associated with an individual.

Thus, it has been envisaged to compute a key by applying mathematical algorithms to biometric data of a user, the key being able to be used to secure a communication link involving this user. According to the initiators of this technique, the key could be retrieved at any time from a biometric capture performed on the user. Furthermore, such a key had to be distinctive, that is, different for each user. However, this technique presents drawbacks that make it difficult to implement in practice.

Firstly, the acquisition of biometric data is subject to a major disadvantage. In practice, two successive captures can give very different results, for example, in the case of fingerprint captures, according to the angle with which the finger is presented and the pressure exerted by the finger on the fingerprint sensor. Regardless of the complexity of the mathematical algorithms implemented on the acquired biometric data, it seems very difficult to guarantee that the key obtained will always be the same for a given user, while remaining meaningful.

Moreover, this technique is implicitly based on the assumption that the biometrics of a user are secret and reserved to that user. This assumption is in reality erroneous, since it is, for example, easy to obtain the fingerprints of a user by simply analyzing the surface of objects touched by the latter. Given that, in this technique, a user's key is completely determined from his biometrics, an attacker having biometric data of that user could therefore obtain his key and thus freely access the communication link involving that user.

One aim of the present invention is to obtain a security key using biometric data, but without the abovementioned drawbacks.

Another aim of the invention is to obtain a communication link that is secured against passive attacks (listening in), using biometric data.

The invention thus proposes a method for providing a secured communication link between a user and an entity having a first set of biometric data relating to the user. The method comprises the following steps:
obtaining a second set of biometric data relating to the user;
implementing an information reconciliation phase in which an error-correction protocol is applied to the first set of biometric data and to the second set of biometric data, so that the resultant data is identical with a predetermined probability level; and
implementing a secret amplification phase in which a hashing function is applied to said resultant data to obtain a key common to the user and to the entity.

Since the second set of biometric data relating to the user is not transmitted over a communication link, a possible attacker cannot obtain it. Even if this attacker has biometric data relating to the user, it is highly improbable that the latter will be identical to said second set of biometric data. This is due in particular to the fact that each acquisition of a set of biometric data comprises a large number of errors, that is, differences relative to a reference set of data.

The information reconciliation and secret amplification phases make it possible to ensure that a key that is common to the user and to the entity is obtained, without the latter being able to be also obtained by the attacker not having exactly the second set of biometric data. Such a key can then make it possible to secure a communication link between the user and the entity, for example by authentication or by encryption of the interchanges.

An advantage distillation phase in which the first set of biometric data and the second set of biometric data are processed, so as to gain the advantage over any passive attacker, can, if necessary, be implemented before the information reconciliation phase.

A preliminary step, in which information relating to the user is transmitted to the entity, can also be envisaged. This step can be used in particular for an initial check, so as to calculate a security key only for authorized users. It can also enable the entity to retrieve the first set of biometric data relating to the user when the entity has biometric data relating to a plurality of users.

Advantageously, the transmitted information comprises a third set of biometric data relating to the user. This should be different from the second set of biometric data, to prevent the latter from being accessible to an attacker. It may, for example, result from a new biometric capture. It may also be derived from the second set of biometric data, for example by extracting minutiae therefrom, which presents the advantage of not necessitating multiple successive biometric captures. It is thus possible to have a secured communication link between an authorized user and an entity, simply based on biometric data.

The invention also proposes a device able to communication with an entity. The device comprises:
means for obtaining a set of biometric data relating to a user;
means for applying an error-correction protocol to the biometric data; and
means of hashing the data delivered by the means for applying an error-correction protocol to the biometric data, so as to obtain a key.

The invention also proposes an entity able to communicate with a user, the entity having a first set of biometric data relating to said user. The entity comprises:
means for applying an error-correction protocol to the first set of biometric data; and
means of hashing the data delivered by the means for applying an error-correction protocol to the first set of biometric data, so as to obtain a key.

Other features and advantages of the present invention will become apparent from the description below of nonlimiting exemplary embodiments, with reference to the appended drawings in which:

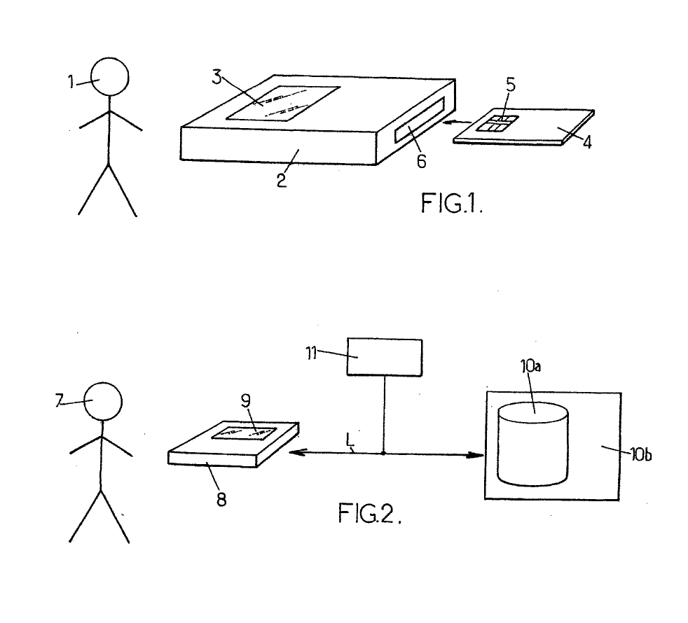

FIGS. 1-2 are diagrams showing exemplary systems in which the invention can be implemented;

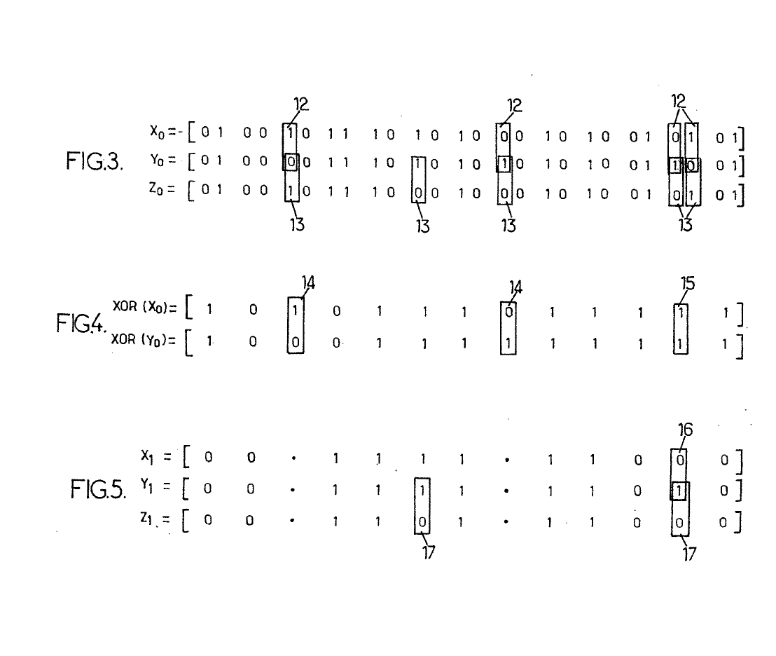

FIGS. 3-6 show simplified digital strings implemented in an exemplary embodiment of the invention;

FIG. 7 is a diagram simply illustrating a hashing operation implemented in one exemplary embodiment of the invention.

FIGS. 1 and 2 show a user 1 or 7 wanting to use a secured link with an entity 4 or 10b.

In the example illustrated in FIG. 1, the entity concerned is a chip card 4. This card can, for example, be a payment card or a subscriber identity card such as a SIM card (Subscriber Identity Module) for example. The chip 5 of the card 4 stores information dependent on the target application. It also stores a set of biometric data of the user 1 to whom the card 4 belongs. The set of biometric data concerned can be of any type. Advantageously, it can be defined from a fingerprint, a characteristic of the iris or of the voice of the user 1. The chip 5 also includes computation capabilities, certain operations of which are detailed hereinafter.

Moreover, a device 2, which is, for example, a payment terminal or a communication terminal such as a portable telephone, can be used by the user 1. This terminal is arranged to cooperate with the chip card 4. More specifically, the terminal 2 is capable of receiving the card 4, for example in a slot 6 provided for this purpose. When the card 4 is inserted into the terminal 2, the chip 5 is in contact with corresponding connection terminals of the terminal, which constitutes a communication link between the card 4 and the user 1 via the terminal 2. Furthermore, the terminal 2 is provided with computation capabilities, certain operations of which will be detailed hereinafter.

A biometric sensor 3 is provided to obtain a set of biometric data of the user 1. In the example illustrated in FIG. 1, this sensor is an integral part of the terminal 2. It will, however, be understood that the sensor could be external to the terminal 2, while being capable of transmitting to the terminal 2 the biometric data that it acquires. It is also possible for a set of biometric data of the user 1 to be acquired in another way.

FIG. 2 shows another exemplary system in which the entity concerned is a remote entity 10b comprising a remote database 10a, and with which the user 7 wants to be able to communicate securely. The database 10a stores, for example, biometric data relating to a plurality of users. The entity 10b also includes computation capabilities, certain operations of which will be detailed hereinafter. This entity is, for example, an IT system, such as a communication server.

Moreover, a device 8 comprising a biometric sensor 9 is arranged to communicate with the entity 10b. It is also provided with communication means so that the user 7 can have a communication link L with the entity 10b.

This communication link is carried, for example, by a wired or wireless link. Furthermore, the device 8 is provided with computation capabilities, certain operations of which will be detailed hereinafter.

It is assumed that a passive attacker is capable of listening in to the information exchanged over the communication link between the user 1 or 7 and the entity 4 or 10b. In the example illustrated in FIG. 2, this attacker can, for example, have a probe on the communication link L, so as to obtain the information transmitted over this link. Furthermore, the attacker can perform any type of operations on the information acquired in order to thwart the security implemented between the user and the entity. As an example, the attacker can apply the same operations as the user and the entity if he knows them.

According to the invention, the aim is to obtain a key, without the attacker being able to acquire it himself. This key can then be used to implement security mechanisms between the user and the entity.

To this end, a set of biometric data of the user concerned is obtained, at the same time as the biometric data stored on the entity. For example, the set of biometric data can be obtained by the acquisition of a fingerprint of the user using a biometric sensor, such as the sensors 3 or 9 in FIGS. 1 and 2 respectively.

It is assumed hereinafter that the duly acquired biometric data can be described by a digital string, such as the digital string X₀ for example illustrated in FIG. 3. Obviously, other representations of the biometric data could also be used. In the chosen example, the digital string X₀ comprises a small number of bits, or binary elements, to assist in understanding the operations implemented. In reality, the digital strings describing biometric data can be of the order of tens of thousands of bits for example.

Moreover, as indicated above, the entity concerned, for example the chip card 4 or the entity 10b of FIGS. 1 and 2 respectively, has biometric data relating to one or several users. It is assumed hereinafter that a set of biometric data is stored in particular for the user concerned, that is, the user 1 or 7 in FIGS. 1 and 2 respectively. This set of biometric data can also be described by a digital string, such as the digital string Y₀ represented in FIG. 3.

It can be seen that the digital strings X₀ and Y₀ present a certain number of differences 12 (four differences in the example illustrated in FIG. 3). This is due to the fact, mentioned in the introduction, that there is a wide variability in biometric measurements. In other words, if the digital string Y₀ is considered, by convention, as the reference string, any new digital string X₀ obtained from a new acquisition of biometric data will include “errors” compared to this reference string. It will be noted that other choices of reference string are also possible, such as X₀ for example.

Obviously, these errors cannot be predicted because they depend on many factors, such as the angle at which the finger is presented and the pressure exerted by the finger on the sensor when the biometric data comprises fingerprints for example. Furthermore, they cannot be determined in particular by a passive attacker, particularly because the digital string X₀ is not transmitted to the entity.

As seen above, an attacker can himself have a set of biometric data relating to the user concerned. The latter may, for example, have been acquired from fingerprints left on the surface of objects touched by the user. It will therefore be understood that the set of biometric data obtained in this way by the attacker will normally be less precise than that acquired from the user using a biometric sensor for example. However, it is also possible to imagine that the attacker has a set of biometric data of the user that is very reliable.

In the example illustrated in FIG. 3, the digital string representing the set of biometric data relating to the user and available to the attacker is denoted Z₀. This digital string has five errors, compared to the reference string Y₀, that is, one error more than the digital string X₀. In the example of FIG. 3, an arbitrary choice is made of four of the errors 13 identical to the errors 12. However, generally, it will be noted that the errors contained in Z₀ should be independent of those contained in X₀, the latter being inaccessible to the attacker.

Advantageously, an advantage distillation phase is carried out in which the probability is increased of the attacker having a digital string presenting a larger number of errors than the digital string obtained on the user side, for example by the device 2 or 8 of FIGS. 1 and 2 respectively. In other words, this phase enables the user-entity pair to gain the advantage over the passive attacker. An example of operations implemented in such an advantage distillation phase was disclosed by Martin Gander and Ueli Maurer in the article “On the secret-key rate of binary random variables, Proc. 1994 IEEE International Symposium on Information Theory (Abstracts), 1994”, page 351. Obviously, other operations can be implemented provided that they make it possible to gain the advantage over the passive attacker.

It will also be noted that this advantage distillation phase may not be implemented because, as mentioned above, the attacker will normally from the outset have a digital string including more errors than that of the user himself. However, when there is a risk that the attacker has a digital string with fewer errors, it is preferable to perform this phase.

In an example of such an advantage distillation phase, the digital strings X₀ and Y₀ are broken down into groups of N digital values, with N being an integer number. In the example illustrated in FIGS. 3 and 4, the bits of X₀ and Y₀ are grouped together in pairs (N=2). Then, for each duly identified pair, an “exclusive OR” (XOR) is applied so as to obtain a “1” when the bits of the pair concerned are different and a “0” when they are the same.

The results of the exclusive OR are then compared over corresponding groups (that is groups of the same rank) of X₀ and Y₀. For this, each of the user (or the device that he is using) and the entity communicates to the other the results of the exclusive OR that it has performed.

New digital strings X₁ and Y₁ are then determined, retaining for example the first digital values of each group of X₀ and Y₀ respectively for which the result of the exclusive OR is the same as for the corresponding group of the other digital string (Y₀ or X₀). The other groups are disregarded and are not taken into account in forming the digital strings X₁ and Y₁.

In the example illustrated in FIG. 4, two differences can be seen between the bits of the exclusive OR performed respectively on X₀ and Y₀ (differences 14). It will be noted that the exclusive OR performed on the penultimate pair (reference 15 in FIG. 4) has the same result, namely a “1” for X₀ and Y₀, because each of the two bits of the pair concerned of X₀ differs from the corresponding bits of Y₀.

The digital strings X₁ and Y₁ resulting from this advantage distillation phase are represented in FIG. 5. Y₁ then becomes the new reference. It can be seen that X₁ and Y₁ present just one difference between them (difference 16), compared to four differences between X₀ and Y₀. It will thus be understood that the advantage distillation can rapidly reduce the number of differences between the digital strings of the user and of the entity.

If the passive attacker decides to act like the user (or the device that he is using) and the entity, he can then capture the results of the exclusive OR exchanged between them and deduce therefrom a string Z₁ according to the same principles. Z₁ then comprises the first bit of each pair of Z₀ having the same rank as two corresponding pairs of X₀ and Y₀ for which the same result of the exclusive OR has been obtained. As FIG. 5 shows, the digital string Z₁ obtained in the example comprises two differences with Y₁ (differences 17), or one difference more than X₁.

The advantage distillation phase can be repeated a number n of times, with n being an integer number, until the digital string Xₙ has an error rate compared to Yₙ less than a chosen threshold. For example, the number n can be chosen according to an average rate of variability of the biometric data acquisition measurements.

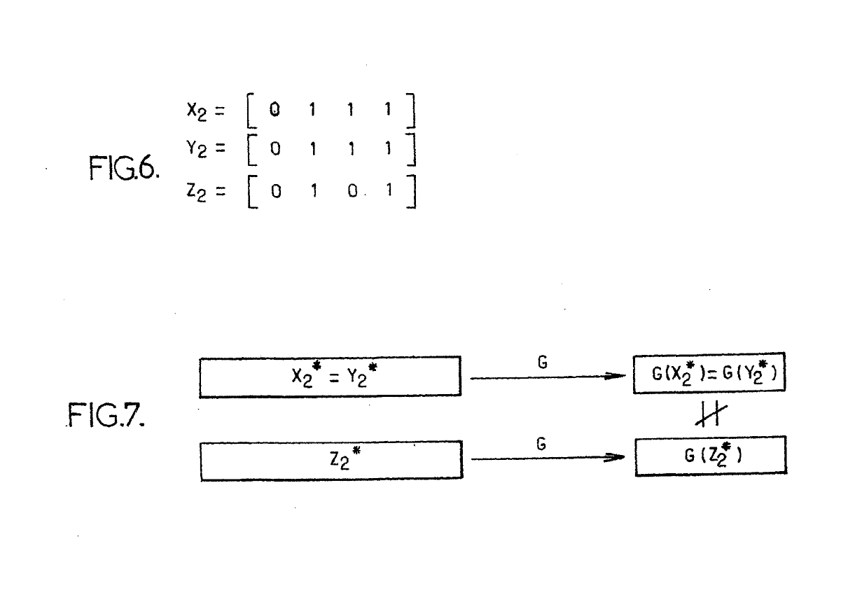

In the example illustrated in the figures, a match between the digital strings on the user side and the entity side is obtained from the second pass of the advantage distillation phase. In practice, as is shown in FIG. 6, the strings X₂ and Y₂ are the same.

However, the string Z₂ obtained in the second pass by a passive attacker implementing the same operations as the user and the entity remains different from the reference string Y₂.

It can be shown that, whatever the technique employed by the attacker to try to discover the digital strings obtained by the user and the entity, this attacker will always obtain an erroneous digital string, namely a string that is different from those of the user and the entity.

An information reconciliation phase is then implemented. It consists in further eliminating residual errors in the digital string of the user (or of the entity when the reference is the user's string), for cases where the advantage distillation has not already eliminated all the errors.

In this information reconciliation phase, an error-correction protocol is used. This protocol should preferably be chosen to minimize the information transmitted between the user and the entity and which could represent relevant information that could be exploited by the attacker.

One exemplary protocol is the “Cascade” protocol described by G. Brassard and L. Salvail in the article “Secret-key reconciliation by public discussion, EUROCRYPT '93: Workshop on the theory and application of cryptographic techniques on Advances in cryptology, Springer-Verlag New York, Inc., 1994, pp. 410-423”.

With the Cascade protocol, the two parties to the communication randomly and publicly agree on a permutation that they apply respectively to the digital strings that they have obtained after the advantage distillation. The result of these permutations is then split up into blocks of a determined adaptive size. For each block obtained in this way, a DICHOT primitive is executed. When the parity of the corresponding blocks for the two parties is identical, the calculated primitive returns the position of a difference within these blocks. Then one of the parties corrects this error. Additional so-called “backtracking” steps are also provided to ensure that the whole referencing all the blocks whose parity has been modified following the correction of an error is ultimately empty.

At the end of the information reconciliation phase, the user and the entity have one and the same digital string with a predetermined probability level. In the example described with reference to the figures, X₂* and Y₂* are used to denote the identical digital strings obtained in this way on the user side and the entity side respectively, namely the strings X₂ and Y₂ after correction. The attacker has a digital string Z₂* which differs from X₂* and Y₂*, thanks in particular to the properties of the advantage distillation and/or information reconciliation phases.

A third so-called secret amplification phase is then implemented. The purpose of such a phase was disclosed by Charles H. Bennett, Gilles Brassard, Claude Crepeau and Ueli M. Maurer, in the article “Generalized privacy amplification, IEEE Transaction on Information Theory (1995)”. It consists in applying a hashing function to the digital strings obtained by the user and the entity after the preceding phase, that is, to X₂* and Y₂* in our example.

A hashing function is a compression function that makes it possible to obtain information that is shorter than initial information to which it is applied.

One example of hashing function that can be used is that disclosed by Kaan Yüksel, in the document “Universal hashing for ultra-low-power cryptographic hardware applications, Master's thesis, Worcester Polytechnic Institute, 2004”. The advantage of this function is that it requires very little in the way of computing resources.

FIG. 7 shows the application of the hashing function G to X₂* and Y₂*. Since X₂*=Y₂*, we also have G(X₂*)=G(Y₂*). Thus, the user (or the device that he is using) and the entity ultimately have one and the same digital string of limited size. In a real case, G(X₂*) and G(Y₂*) are, for example, digital strings comprising around a hundred bits.

Conversely, the attacker has a string Z₂* different from X₂* and Y₂*. Even if this attacker knows the hashing function used by the user and the entity, and tries to compute G(Z₂*), he will thus obtain a digital string that is different from G(X₂*) and G(Y₂*).

In practice, to ensure that the digital strings G(X₂*) and G(Y₂*) are sufficiently meaningful, that is, that they take sufficiently distinctive values according to the starting digital strings X₂* and Y₂*, it is possible to define a threshold number of bits, so that G(X₂*) and G(Y₂*) are computed only if X₂* and Y₂* comprise a number of bits greater than this threshold. Such a threshold can, for example, be located between a few tens and a few hundreds of bits.

Subsequently, the digital string G(X₂*)=G(Y₂*) common to the user and the entity can be used to have a communication link that is secured between them. This string thus constitutes a secret key shared only by the user and the entity. It can, for example, be used to authenticate the user. To this end, authentication information, such as an identification code for example, can be transmitted from the user to the entity, this information being encrypted using said key. The key can also be used to encrypt any information transmitted over the communication link between the user and the entity. Other applications can also be envisaged from the determination of this key.

In the above description, it has been assumed that the set of biometric data relating to the user concerned was directly available on the entity. This can, in practice, be the case when the set of biometric data of the user is the only data to be stored on the entity. For example, in the case illustrated in FIG. 1, the chip card 4 belongs to the user 1 and stores only his biometric data, so that there is no ambiguity as to the set of biometric data to be selected for implementing, on the chip card 4, the operations described above.

On the other hand, when several sets of biometric data relating to different users are stored in a memory of the entity, as is the case of the database 10a of FIG. 1, it is then appropriate to communicate to the entity 10b information relating to the user 7 which will enable it to retrieve the corresponding set of biometric data, in order to apply to it the operations described above. The information transmitted can be of any type, since there is no drawback in transmitting it in an unsecured way. It may, for example, be an identity of the user concerned. The database 10a should then store the identities of each user correlated with their biometric data, so as to be able to determine the set of biometric data of the user 7 on receiving his identity.

In one advantageous embodiment of the invention, a check is performed prior to implementing at least some of the operations described above, such as the advantage distillation, information reconciliation and secret amplification phases. The aim of this check is to prevent a secured link with the entity from being able to be opened for just anyone.

In this embodiment, it is assumed that the entity stores in memory the biometric data of the authorized users, that is, those users for whom the use of a secured link is authorized. Information relating to the user is transmitted to the entity. On receipt by the entity, this information will be used to check that a set of biometric data is stored in the memory of the entity, in order to determine if it is an authorized user. The operations described above will then be implemented only if it is an authorized user.

When the entity stores in memory biometric data relating to a plurality of users, the same information transmitted by a user can be used to check that it is an authorized user and to retrieve the corresponding set of biometric data as described above. Thus, the transmitted information can be of any type, since there is no drawback in transmitting it in an unsecured way. It may, for example, be an identity of the user concerned.

In a particularly advantageous embodiment, the information transmitted to the entity is a set of biometric data of the user. Thus, all the operations implemented by the invention, both for the initial check and for the key computation, are performed on the basis of biometric data.

The biometric data transmitted to the entity may, for example, result from an acquisition performed using a biometric sensor, such as the sensor 3 or 9 of FIGS. 1 and 2 respectively. Transmitting the biometric data (similar to a digital string with the errors that it includes) on which the various operations described above will be performed will, however, be avoided. In practice, such an uncoded transmission could be listened into by the passive attacker, who might then be capable of computing the key in the same way as the user of the entity.

Thus, if X₀ is used to denote the digital string relating to the user and on which the operations described above are carried out, it is possible to transmit to the entity a digital string X₀′, obtained from another biometric acquisition. This raises no problems because, due to the variability of the measurements performed by the biometric sensor, the string X₀′ includes errors different from those presented by X₀. Any attacker obtaining the string X₀′ would not in any way be able to deduce therefrom a key identical to that obtained by the user from X₀.

Advantageously, the set of biometric data transmitted to the entity can be derived from that on which the operations described above are carried out such as the digital string X₀ of the above example. This mode of operation presents the advantage that the user does not need to undergo two successive biometric captures. The set of biometric data transmitted can, for example, take the form of the digital string X₀ in which modifications have been introduced. In this case, care will be taken to ensure that the modifications introduced are sufficient to prevent an attacker being able to retrieve the string X₀.

As a variant, the set of biometric data transmitted comprises minutiae, that is, data extracted from the set of biometric data on which the operations described above are carried out. For example, if the set of biometric data acquired relates to a fingerprint, the minutiae concerned may comprise a few distances between reference points of this fingerprint. In this way, the user can be assigned a key from a single capture of biometric data.

It will be understood that, in the case where the information transmitted to the entity comprises a set of biometric data, the latter can be used by the entity to check whether the user concerned is authorized or not. To this end, when the entity stores in memory a single set of biometric data, as might be the case in the example illustrated in FIG. 1 where the chip card 4 stores in its chip 5 the set of biometric data relating to its user 1, the abovementioned check consists in comparing the set of biometric data transmitted with that stored in the memory of the entity. When the entity stores in memory a plurality of sets of biometric data, as might be the case in the example illustrated in FIG. 2 where the entity 10b stores in its database 10a the biometric data of different users, the abovementioned check may consist in comparing the set of biometric data transmitted with each of the sets of biometric data stored in the memory of the entity, to detect any match between them.

If minutiae, or other data extracted from a basic set of biometric data, are transmitted to the entity, the latter should then obtain corresponding minutiae from the set of biometric data that it stores in memory, in order for the minutiae to be able to be compared.

1. A method for providing a secured communication link between a user and an entity having a first set of biometric data relating to the user, the method comprising the following steps:
obtaining, on the user side, a second set of biometric data relating to the user;
implementing an information reconciliation phase between the user and the entity, in which an error-correction protocol is applied to the first set of biometric data and to the second set of biometric data, so that the resultant data, on the user side and the entity side, is identical with a predetermined probability level; and
implementing a secret amplification phase in which a hashing function is applied to said resultant data to obtain a key common to the user and to the entity.

2. The method as claimed in claim 1, in which, before the information reconciliation phase, an advantage distillation phase is implemented in which the first set of biometric data and the second set of biometric data are processed so as to gain the advantage over any passive attacker.

3. (canceled)

4. The method as claimed in claim 1, in which the second set of biometric data is obtained using a biometric sensor.

5. The method as claimed in claim 1, also comprising a preliminary step in which information relating to the user is transmitted to the entity.

6. The method as claimed in claim 5, in which the transmitted information comprises a third set of biometric data relating to the user, in which the first and third sets of biometric data are compared, the information reconciliation and secret amplification phases being implemented only when said comparison reveals a match between the first and third sets of biometric data.

7. The method as claimed in claim 5, in which the entity has biometric data relating to a plurality of users, and in which said first set of biometric data is retrieved, on the entity, from transmitted information, the information reconciliation and secret amplification phases being implemented only when said first set of biometric data has been retrieved from said transmitted information.

8. The method as claimed in claim 7, in which the information transmitted to the entity comprises an identity of the user.

9. The method as claimed in claim 7, in which the transmitted information comprises a third set of biometric data relating to the user.

10. The method as claimed in claim 6, in which the third set of biometric data comprises information derived from the second set of biometric data.

11. The method as claimed in claim 10, in which the third set of biometric data comprises minutiae obtained from the second set of biometric data.

12. The method as claimed in claim 6, in which the third set of biometric data is obtained using a biometric sensor and is distinct from the second set of biometric data.

13. The method as claimed in claim 1, also comprising a subsequent authentication step in which the user transmits to the entity information from which the entity can authenticate the user, said information being encrypted using the key obtained.

14-23. (canceled)

24. A system for having a secured communication link between a user and an entity having a first set of biometric data relating to the user, the system comprising:
means for obtaining, on the user side, a second set of biometric data relating to the user;
means for implementing an information reconciliation phase between the user and the entity, in which an error-correction protocol is applied to the first set of biometric data and to the second set of biometric data, so that the resultant data, on the user side and the entity side, is identical with a predetermined level of probability; and
means for implementing a secret amplification phase in which a hashing function is applied to said resultant data to obtain a key that is common to the user and to the entity.

25. The method as claimed in claim 9, in which the third set of biometric data comprises information derived from the second set of biometric data.

26. The method as claimed in claim 9, in which the third set of biometric data is obtained using a biometric sensor and is distinct from the second set of biometric data.
